(19) United States
(12) Patent Application Publication
(10) Pub. No.: US 2003/0089022 A1
(43) Pub. Date: May 15, 2003

(54) Buoyancy sleeve rod and reel saver

(76) Inventor: Michael Costephens, Cheyenne, WY (US)

Correspondence Address: Michael Costephens, 6705 Braehill Rd. Lot C4, Cheyenne, WY, 82009, US

(21) Appl. No.: 09/923,490

(22) Filed: Aug. 3, 2001

(51) Int. Cl. A01K 87/00

(52) U.S. Cl. 43/25

(57) ABSTRACT

The sleeve is made from a 3 inch round piece of Styrofoam, the Styrofoam is 8 inches long, with a 2 inch hole cut down through the middle of the Styrofoam.

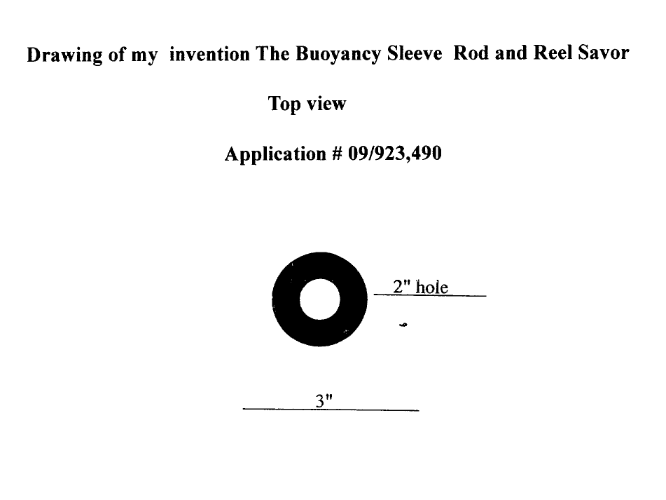

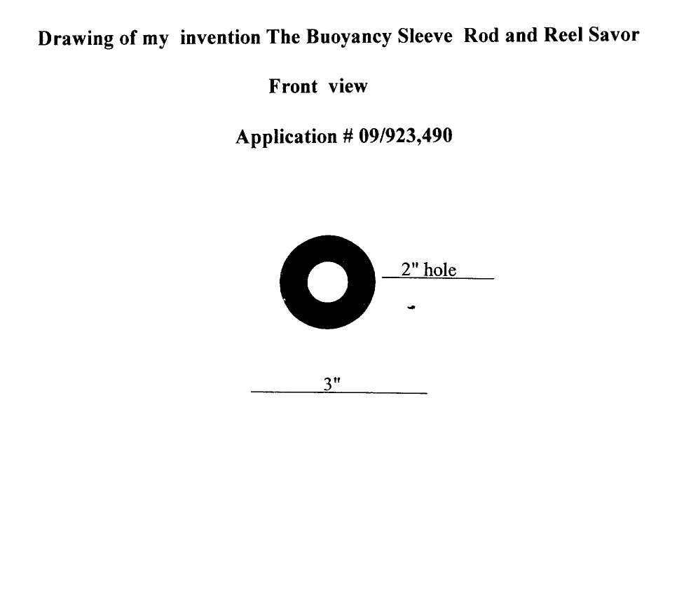

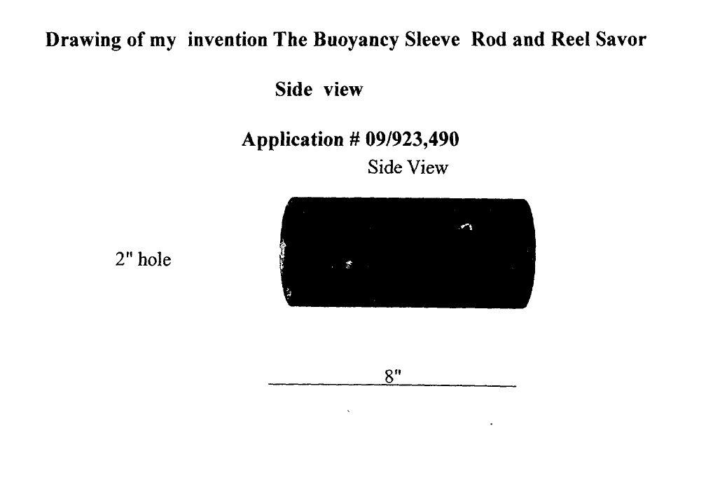

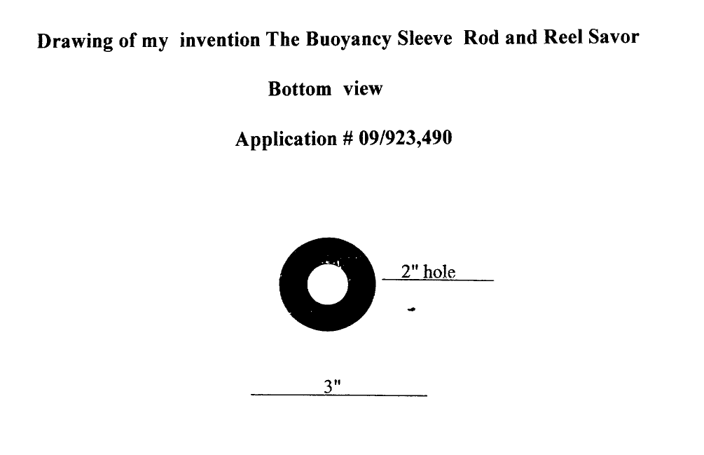

The sleeve is made from a 3 inch round piece of Styrofoam, the Styrofoam is 8 inches long, with a 2 inch hole cut down through the middle of the Styrofoam.

What I claim as my invention

1. This sleeve can be placed on the handle of a rod with the reel attached, leaving enough space for a person's hand so they may cast with a firm grip.
This styrofoam sleeve will form/fit both casting and open face rods. Thick rubber bands can be placed on the rod's handles before the sleeve is placed on it. This method offers extra grip for the sleeve fit.

2. This sleeve will keep suspended on the surface, the weight of three and one-half pounds. The sleeve may be removed at any time.

3. When fishing from shore, bridge or boat and an accident happens or a fish pulls your rig into the water, the buoyancy sleeve rod and reel saver will enable you to retrieve your rig, keeping safety in mind at all times.
